(19) United States
(12) Patent Application Publication
(10) Pub. No.: US 2013/0084536 A1
(43) Pub. Date: Apr. 4, 2013

(54) METHODS AND APPARATUS FOR AN ORTHODONTIC HEADGEAR SLIP

(71) Applicant: Jeannie Saraceni, Litchfield Park, AZ (US)

(72) Inventor: Jeannie Saraceni, Litchfield Park, AZ (US)

(21) Appl. No.: 13/435,986

(22) Filed: Mar. 30, 2012

Related U.S. Application Data
(60) Provisional application No. 61/542,117, filed on Sep. 30, 2011.

(51) Int. Cl. A61C 7/06

(52) U.S. Cl. 433/5; 433/24

(57) ABSTRACT

A method and apparatus for an orthodontic headgear slip, comprising a substantially rectangular body having a pair of ends that are each coupled together, a front side, a back side, a top, and a bottom. The rectangular body comprises a longitudinal opening for receiving a headgear neck-strap on the top of the body and a first and a second opening on the front of the body. The openings are spaced and sized to allow for a first and a second headgear attachment mechanism to be fed from inside of the body to outside of the body.

### CROSS-REFERENCES TO RELATED APPLICATIONS

This application claims the benefit of U.S. Provisional Patent Application No. 61/542,117, filed Sep. 30, 2011, and incorporates the disclosure of such application by reference.

### BACKGROUND OF INVENTION

Orthodontic headgear is designed to attach to various types of orthodontic equipment including, for example, orthodontic braces and palatal expanders. The orthodontic headgear applies additional force to teeth and/or the jaw. There are several types of orthodontic headgear, with each type being better adapted to achieve various results. For example, a high-pull headgear may be fitted with a strap placed around the back and top of the head and is best suited for providing backwards and upper pressure on the user's teeth. A reverse-pull headgear may be fitted on the front of the face and is best suited for providing forward pressure on the user's teeth. A cervical/neck-strap headgear, may be fitted with a strap placed around the back of the neck and provides backward pressure on the teeth.

One of the biggest problems associated with orthodontic headgear is that patients do not wear the headgear as much as they should. The average patient generally must wear his headgear for a significant portion of each day. The patient may elect to not wear *their headgear due to a number of factors, including the additional gum/jaw soreness caused by the pressure exerted by the headgear or the negative social stigma associated with orthodontic headgear. Another factor that may cause someone to not wear orthodontic headgear is pain where the headgear strap meets the skin. This is especially a problem with cervical/neck-strap headgear since the neck-strap comes in direct contact with the bare skin on the back of the neck.

### SUMMARY OF THE INVENTION

A method and apparatus for an orthodontic headgear slip, comprising a substantially rectangular body having a pair of ends that are each coupled together, a front side, a back side, a top, and a bottom. The rectangular body comprises a longitudinal opening for receiving a headgear neck-strap on the top of the body and a first and a second opening on the front of the body. The openings are spaced and sized to allow for a first and a second headgear attachment mechanism to be fed from inside of the body to outside of the body.

### BRIEF DESCRIPTION OF THE DRAWINGS

A more complete understanding of the present invention may be derived by referring to the detailed description and claims when considered in connection with the following illustrative figures. in the following figures, like reference numbers refer to similar elements and steps throughout the figures.

FIG. 1 representatively illustrates an orthodontic headgear being worn by a user;

FIG. 2 representatively illustrates a headgear slip, in accordance with various embodiments;

FIG. 3 representatively illustrates a headgear slip, in accordance with various embodiments;

FIG. 4 representatively illustrates a headgear slip with a headgear neck-band placed in the headgear slip, in accordance with various embodiments;

FIG. 5 representatively illustrates a headgear slip with an internal pocket, in accordance with various embodiments;

FIG. 6 representatively illustrates a top perspective Of a headgear slip, in accordance with various embodiments;

FIGS. 7A and 7B representatively illustrates a top perspective of a headgear slip, in accordance with various embodiments;

FIG. 8 representatively illustrates a top perspective of a headgear strap and attachment mechanism being placed inside a headgear slip, in accordance with various embodiments;

FIG. 9 representatively illustrates a top perspective of a headgear strap and attachment mechanism being placed inside of a headgear slip, in accordance with various embodiments;

FIGS. 10A-D representatively illustrate a headgear slip during various stages of construction in accordance with various embodiments;

FIG. 11 representatively illustrates a plurality of stitches used in various embodiments of a headgear slip.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION

The present invention may be described in terms of functional block components and various processing steps. Such functional blocks may be realized by any number of hardware components and materials configured to perform the specified functions and achieve the various results. For example, the present invention may employ fabrics, thread, adhesive, padding, and the like, which may be arranged in a plurality of ways to carry out a variety of functions and may comprise natural and/or artificial materials. In addition, the present invention may be practiced in conjunction with any number of apparatuses configured to be placed around the neck of a person or animal, and the system described is merely one exemplary application for the invention.

For the sake of brevity, conventional manufacturing, connection, preparation, and other functional aspects of the system may not be described in detail. Furthermore, the connecting lines shown in the various figures are intended to represent exemplary functional relationships and/or connections between the various elements. Many alternative or additional functional relationships or physical connections may be present in a practical system.

Methods and apparatus for an orthodontic headgear slip according to various aspects of the present invention may operate in conjunction with any suitable headgear system. Various representative implementations of the present invention may be applied to any system comprising a strap that is in contact with skin.

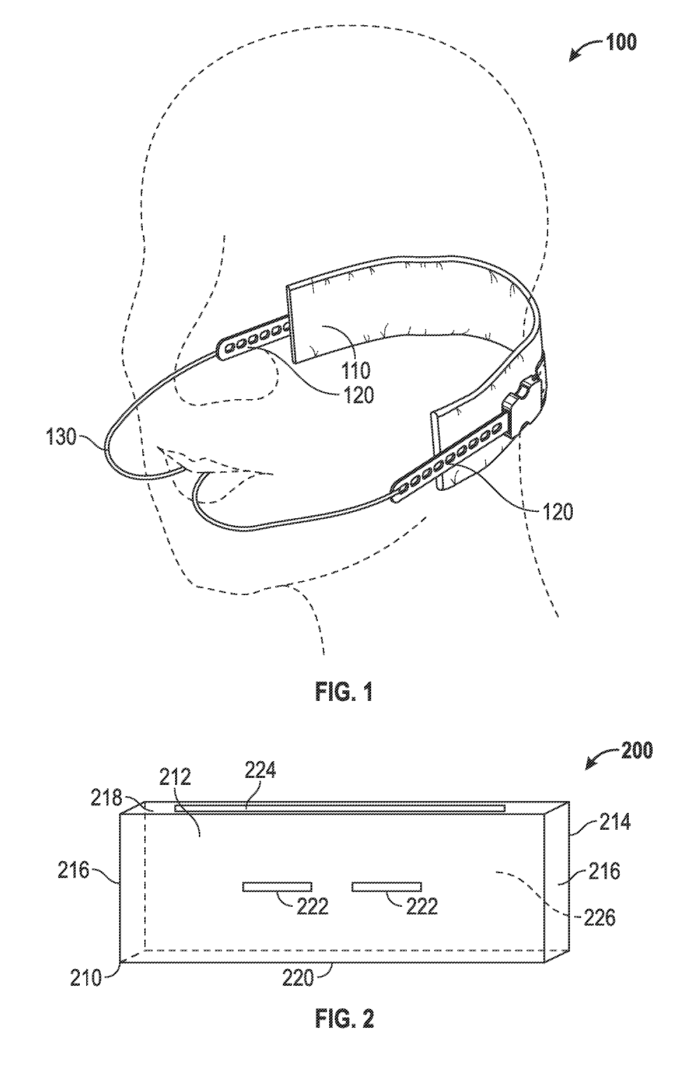

The present invention may be described in terms of various functional components and parts. Referring to FIG. 1, a neck-strap orthodontic headgear 100 is depicted. The neck-strap orthodontic headgear 100 may comprise a neck-strap 110, an attachment mechanism 120, and a facebow 130. The attachment mechanism 120 may be permanently affixed to the neck-strap 110 or may be removable. In operation, the facebow 130 may be first attached to the user's mouth orthodontics and then the facebow 130 may be fastened to the attachment mechanism 120.

The pressure exerted by the neck-strap 110 of the neck-strap orthodontic headgear 100 onto the back of the neck may pose a particular problem. The pressure exerted by the neck-strap 110 can often feel like the neck-strap 110 is cutting into the skin or the strap may cause chaffing. In some cases, the pressure exerted by the neck-strap 110 causes cuts and/or abrasions to the skin. The discomfort associated with the neck-strap 110 may further be amplified if the user has sensitive skin.

A headgear slip may be used to provide a buffer between the neck-strap 110 and the user. In various embodiments, the headgear slip may comprise any suitable structure configured to wrap around the neck-strap 110, providing the user with a better contact surface than the neck-strap 110 by itself. For example, in an embodiment, the headgear slip may be constructed from a soft material, thus providing the headgear user with a layer of padding that does not irritate the skin. In other embodiments, the headgear slip may be configured such that the slip does not provide the user with additional pressure points. Thus, the headgear slip may be configured to have a substantially flat design without any portions that are raised, indented, or otherwise configured to exert pressure on the user. In various embodiments, the headgear slip may comprise an additional cushion to provide the user with even more protection from the neck-strap.

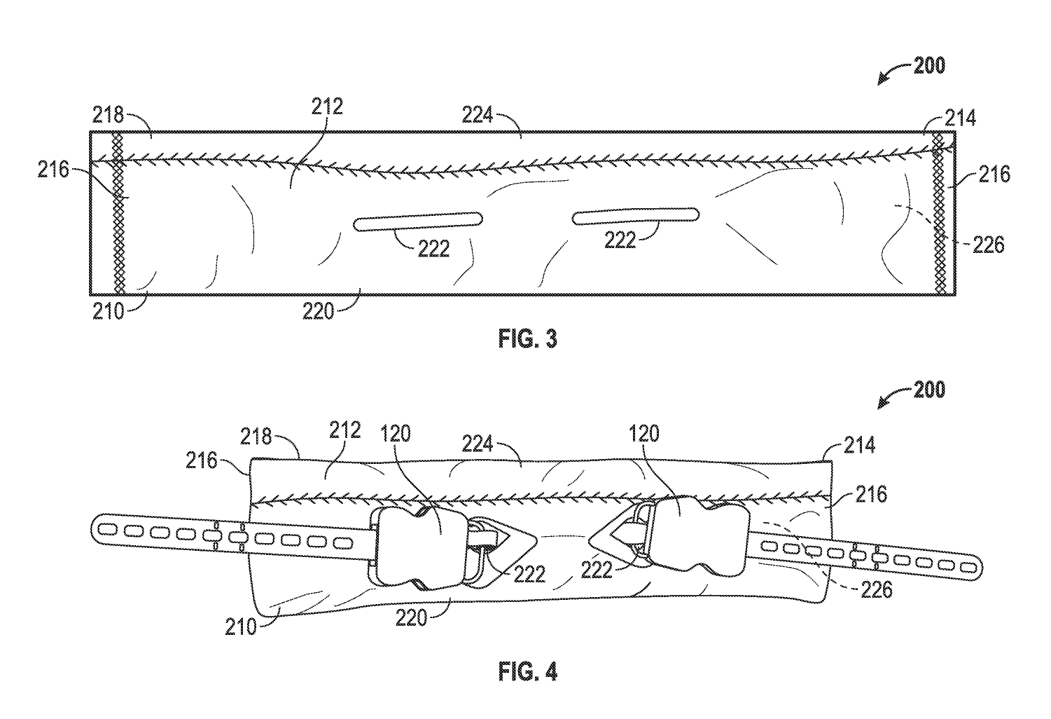

Referring now to FIGS. 2, 3, and 4, according to various embodiments, a headgear slip 200 may comprise a body 210. The body 210 may comprise a first side 212 and a second side 214. The first side 212 and the second side 214 may be attached to form a pair of ends 216, a top 218, and a bottom 220. It should be understood that the body 210 may form any suitable shape. For example, the body 210 may comprise a rectangular or cylindrical shape. In various embodiments, the body 210 may be formed out a single piece of material that is folded to form the first side 212, the second side 214, the pair of ends 216, the top 218 and the bottom 220. In various embodiments, the body 210 may comprise multiple pieces that are attached together in any suitable fashion.

In various embodiments, the first side 212 may comprise a pair of openings 222. The pair of openings 222 may be sized to any appropriate size to receive the attachment mechanism 120. In one embodiment, the pair of openings 222 may comprise button holes that are sized from between 20 mm to 40 mm in length. In various embodiments, the second side 214 and the bottom 220 may comprise any suitable structure for receiving the neck-strap 110 within the headgear slip. Each of the two, ends 216 may be coupled together. The top 218 defines a longitudinal opening 224 that receives the neck-strap 110. The longitudinal opening 224 may be sized such that the longitudinal opening 224 is large enough for the neck-strap 110 to pass through, but small enough so that the neck-strap 110 does not inadvertently pass through. The body 210 further defines a cavity 226 that is large enough to accommodate the neck-strap 110. The cavity 226 may be may be formed by creating a space between the first side 212 and the second side 214. The space may then be partially enclosed by the top 218, bottom 220, and the ends 216. It should be understood that the various parts of the headgear slip 200 may be coupled or fastened by stitches, tape, adhesives, or any other available means.

Referring now to FIG. 4, in various embodiments, the neck-strap 110 may be fed through the longitudinal opening 224 into a cavity 226 of the headgear slip 200: Each of the attachments 120 may also be fed though the corresponding openings 222, allowing for the neck-strap 110 to lay flat inside of the cavity 226.

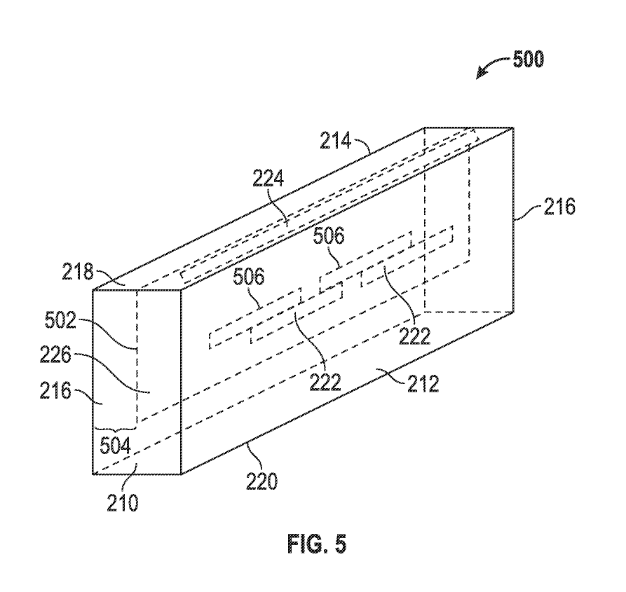

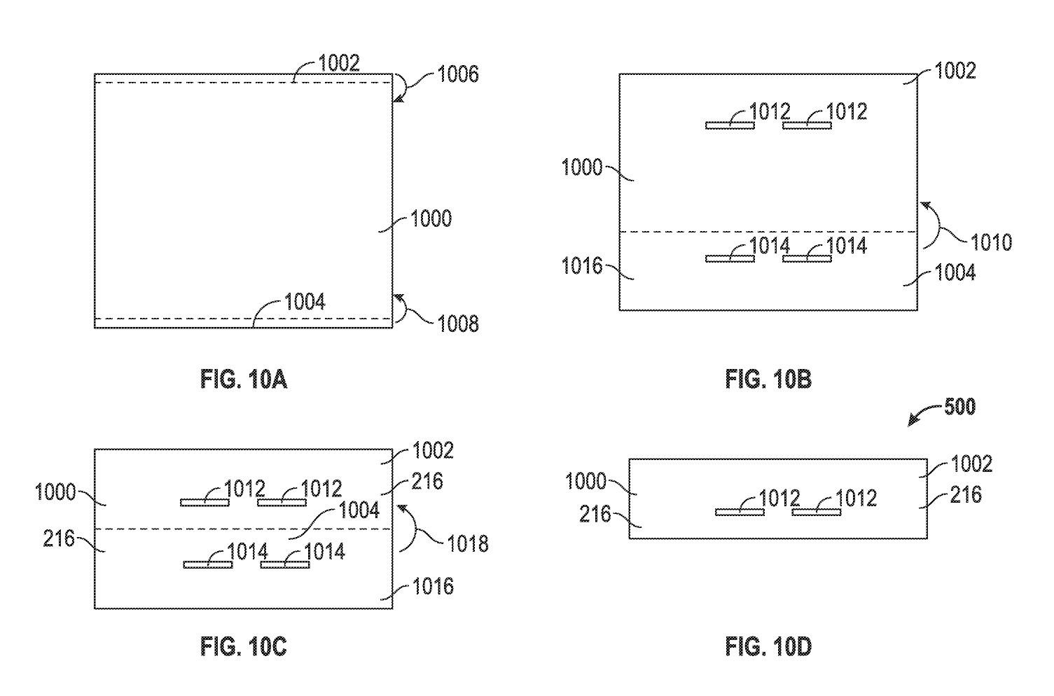

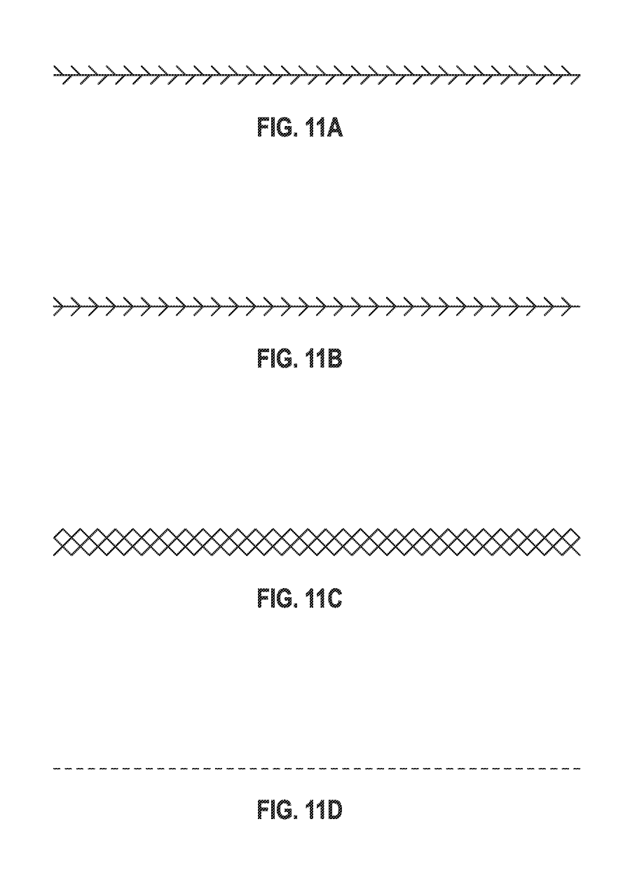

Referring now to FIGS. 5, 6, 7A, and 7B, in various embodiments, the headgear slip 500 may further comprise a flap 502. The flap 502 may be constructed out of the same material as the body 210 or it may be constructed out of a second material. In one embodiment the flap 502 may be fastened to the body 210 using any suitable fastening technique such as with stitches or adhesive. In one embodiment, the flap 502 may be permanently affixed or removable. In one embodiment, the flap may be constructed by increasing the length of material used to construct the body 210 and then folding over the extra length to create the flap 502, this will be further discussed below with reference to FIGS. 10A-D.

In various embodiments, the flap 502 may be used to form a pocket 504 inside the cavity 226. The flap 502 may provide an extra layer of support between the user and the neck-strap 110 and the pocket 504 may be used to store a cushion. In one embodiment, the flap 502 may also comprise a second pair openings 506 aligned with the pair of openings 222 in the body 210. In one embodiment, the pocket 504 may receive the neck-strap 110 and the attachments 120 may be fed through the second pair of openings 506 into the cavity 226 then through the pair of openings 222 to the outside of the headgear slip 500.

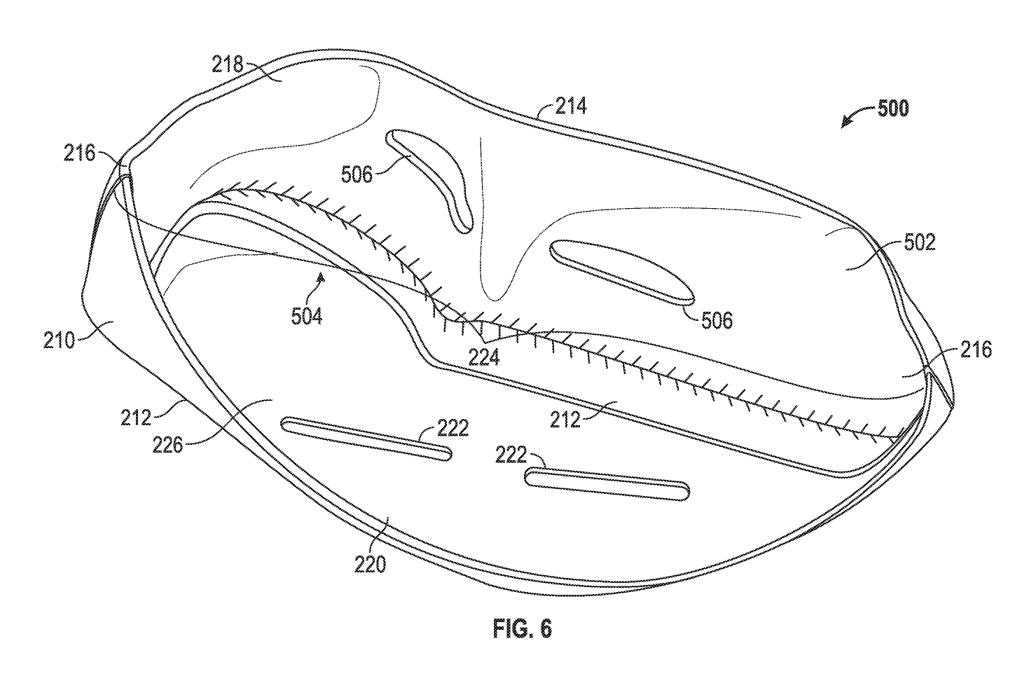

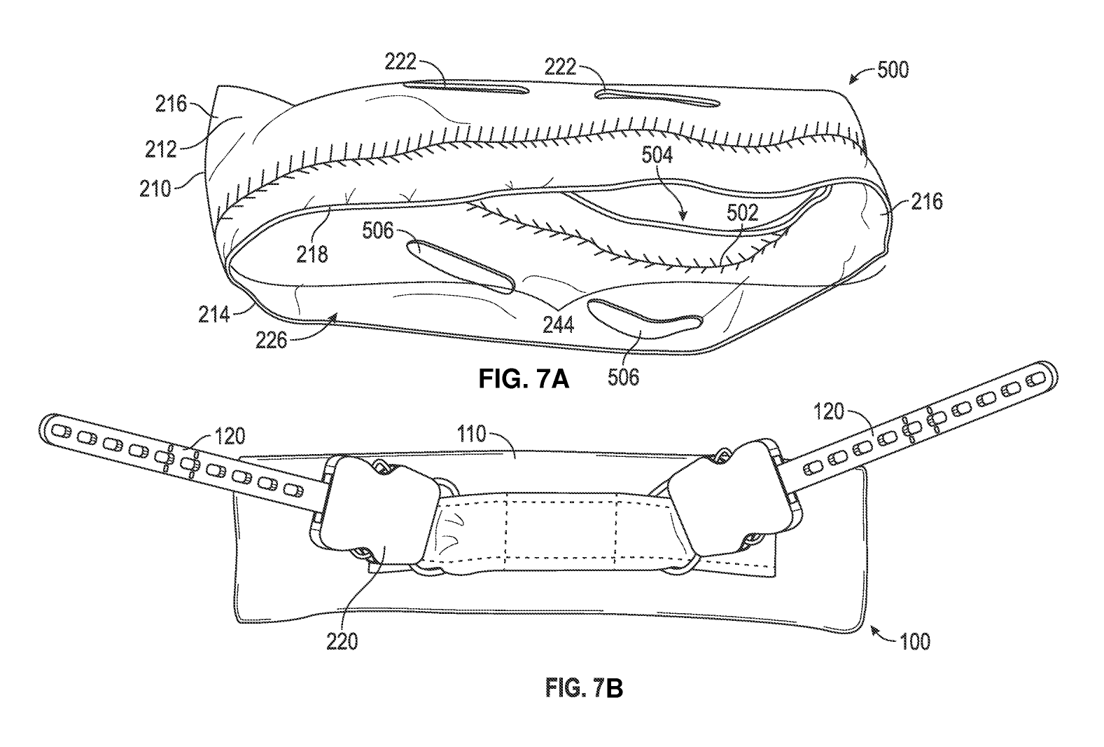

Referring now to FIG. 6, in various embodiments, the longitudinal opening 224 may extend from one side 216 to the other side 216 of the body 210. In one embodiment, the flap 502 may be the same length as the headgear slip 500. Referring now to FIGS. 7A and 7B, the headgear slip 500 may be relatively the same length and width as the headgear strap 100.

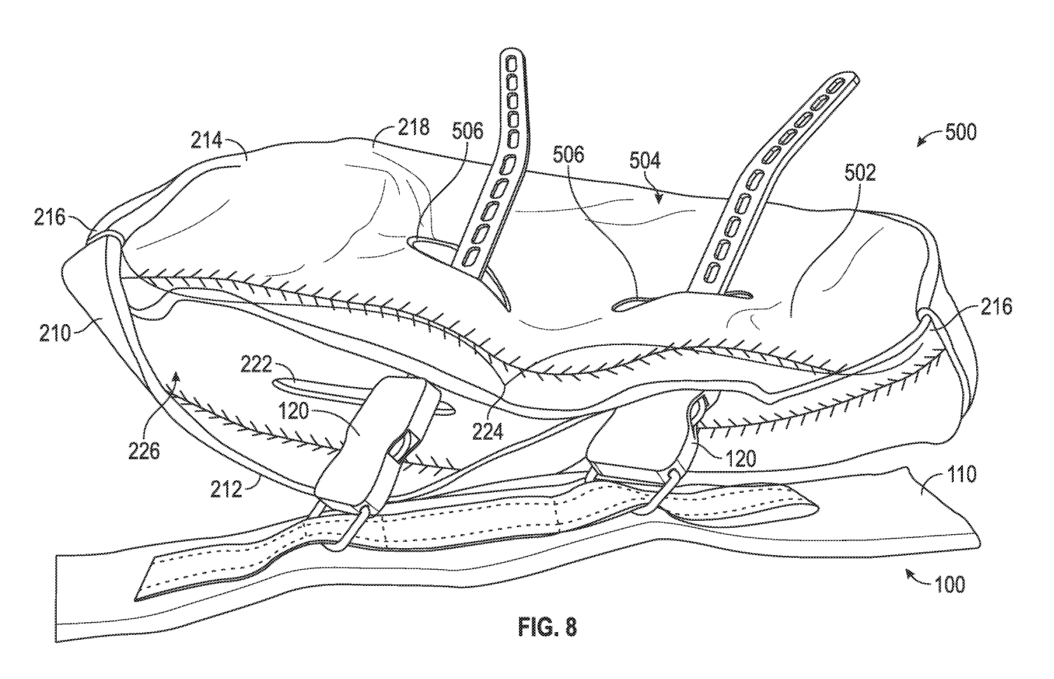

Referring now to FIG. 8, in various embodiments, the headgear 100 may be placed inside of the headgear slip 500. The attachments 120 may be fed through the longitudinal opening 224, through the pocket 504, then through the second pair of openings 506. The headgear strap 100 may then be placed inside of the pocket 504 via the longitudinal opening 224 and into the cavity 226. The attachments 120 may then be fed through each attachment's 120 corresponding opening 222. The headgear 100 may then be worn normally.

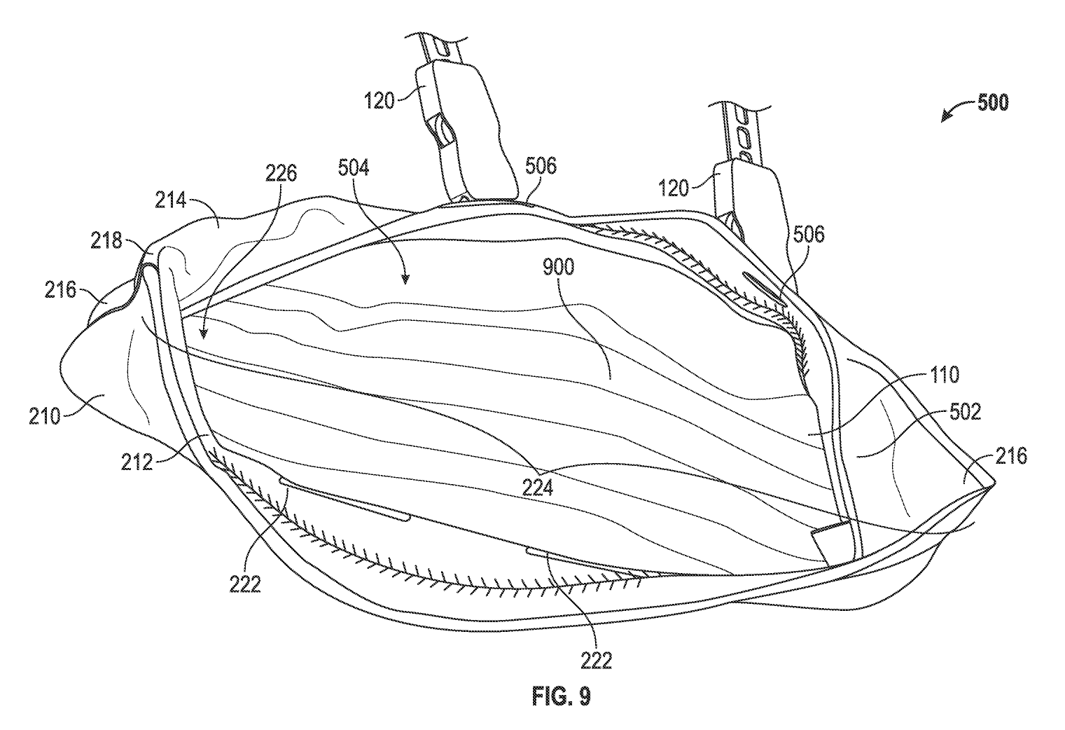

Referring to FIG. 9, in various embodiments, the headgear slip 500 may further comprise a cushion 900. The cushion 900 may be configured to provide the user with additional padding or support. The cushion 900 may be removable or fastened to the headgear slip 500. The cushion 900 may comprise any suitable cushioning material, including cotton, foam, memory foam, or natural or synthetic fibers. In one embodiment, the cushion 900 comprises a hypoallergenic material. In various embodiments, the cushion comprises machine washable materials. The cushion 900 may also be quilted in order to maintain an even distribution of the cushioning materials.

In various embodiments, the headgear slip 500 may be constructed from a soft material in order to maximize the headgear user's comfort. The soft material may comprise any suitable son material, including, but not limited to, natural and man-made fabrics, cotton, silk, neoprene, leather, foam, memory foam, plastics, rubber, or any combination thereof. In various embodiments, the headgear slip 500 may be constructed from an elastic or elastometric material that is capable of stretching to facilitate the passage of the neck-strap 110 through the longitudinal opening 224, and then contracting back to the original shape. In various embodiments, the soft material may be constructed from a machine washable and/or a hypoallergenic material. in various embodiments, the soft material may comprise a light knit-cotton material.

In various embodiments, the headgear slip 500 may be constructed to have a substantially flat profile. In various embodiments, the headgear slip 500 may be constructed from a single piece of material. In various embodiments, the headgear slip 500 may be constructed from multiple pieces of material. With reference to FIGS. 10A, B, C, and D, an unassembled headgear slip 500 is depicted. Referring to FIG. 10A, the headgear slip 500 may comprise a single piece of material 1000 before any modification. The single piece of material 1000 may be substantially rectangular in shape. A top 1002 and a bottom 1004 may be folded to create hems (1006 and 1008). The top 1002 and bottom 1004 of the material 1000 may be fastened using any suitable technique. For example, in one embodiment, the top 1002 and the bottom 1004 may be hemmed or overcast.

Referring now to FIG. 10B, two pairs of openings 1012, 1014 may be cut and finished using any suitable construction technique. For example, in one embodiment, the pairs of openings 1012, 1014 may comprise conventional button holes. In one embodiment, the pairs of openings 1012, 1014 may further comprise a backing to provide support based on the type of materials. In various embodiments, the button holes may be finished using a sewing adhesive. Referring now to FIGS. 10B and IOC, the bottom 1004 may be folded such that the bottom now runs across approximately the middle of the material 1000 creating a flap 1016 (1010).

Referring now to FIGS. 10C and 10D, the material 1000 may then be folded (1018) and the ends 216 may fastened creating the Finished headgear slip 500. Once the ends 216 have been fastened, the flap 1016 forms a pocket capable of receiving the neck-strap 110 and, in various embodiments, the cushion 900. In one embodiment, the ends 216 may be sewn with stitching that allows the headgear slip 200 to be hemmed or overcast while still allowing flexibility with the material while allowing for the ends 216 to remain substantially flat.

The headgear slip 500 may utilize any suitable technique to fasten the various parts together and/or to maintain the structure of the headgear slip 500. In one embodiment, the headgear slip 500 comprises a knit cotton fabric. in this embodiment, the structure of the headgear slip 500 may be maintained by using conventional sewing techniques. For example, in one embodiment, the various parts of the headgear slip are sewn together. Referring now to FIG. 11, a plurality of stitches are depicted. In one embodiment, the various hems and overcasts may comprise an elastic stitch. For example, stitch A, stitch B, and stitch C are each conventional elastic stitches. In various embodiments, the stitching on the ends 216 may comprise a stitch optimized for strength. Stitch D is an example of a stitch optimized for strength. The stitching selected may comprise a stitch that is substantially fiat and/or allows the headgear slip 200 to retain a substantially flat profile.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and, unless otherwise noted, are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. An orthodontic headgear slip, comprising:
a substantially rectangular body having a pair of ends, a front side, a back side, a top, and a bottom, wherein the body comprises:
a longitudinal opening for receiving a headgear neck-strap on the top of the body; and
a first and a second opening on the front of the body, wherein the openings are spaced and sized to allow for a first and a second headgear attachment mechanism to be fed from inside of the body to outside of the body.

2. The orthodontic headgear slip of claim 1, wherein the first and second openings in the body comprise button holes.

3. The orthodontic headgear slip of claim 2, wherein the button holes comprise a length measuring approximately 20 mm to 40 mm in length.

4. The orthodontic headgear slip of claim 1, wherein the body further comprises an inner pocket.

5. The orthodontia headgear slip of claim 4, wherein the inner pocket comprises a third and a forth opening aligned with the first and second openings, wherein the openings are spaced and sized to allow for headgear attachments to be fed outside of the pocket, through the first and second openings to outside of the body.

6. The orthodontic headgear slip of claim 1, wherein the ends are each coupled using an elastic stitch.

7. The orthodontic headgear slip of claim 1, wherein the body lays substantially flat when the headgear neck-strap is placed inside of the body.

8. The orthodontic headgear slip of claim 1, further comprising a cushion placed inside of the body.

9. The orthodontic headgear slip of claim 8, wherein the cushion comprises a hypoallergenic material.

10. The orthodontic headgear slip of claim 1, wherein the body comprises at least one of a soft material, a hypoallergenic material, and an elastic material.

11. An orthodontic headgear slip, comprising:
a substantially rectangular body having a pair of ends, a front side, a back side, a top, and a bottom, wherein the body comprises:
a longitudinal opening for receiving a headgear neck-strap on the top of the body;
an inner pocket inside of the body for receiving the headgear neck-strap;
a first and a second opening on the front of the body, wherein the openings are spaced and sized to allow for a first and a second headgear attachment mechanism to be fed from inside of the body to outside of the body; and
a third and a forth opening on the inner pocket and aligned with the first and second openings, wherein the openings are spaced and sized to allow for headgear attachments to be fed outside of the pocket, through the first and second openings to outside of the body.

12. The orthodontic headgear slip of claim 11, wherein the first, second, third, and fourth openings comprise button holes.

13. The orthodontic headgear slip of claim 12, wherein the button holes comprise a length measuring approximately 20 mm to 40 mm in length.

14. The orthodontic headgear slip of claim 11, wherein the ends are each coupled using an elastic stitch.

15. The orthodontic headgear slip of claim 11, wherein the body lays substantially flat when the headgear neck-strap is placed inside of the body.

16. The orthodontic headgear slip of claim 11, further comprising a cushion placed inside of the body.

17. The orthodontic headgear slip of claim 1, wherein the body comprises at least one of a soft material, a hypoallergenic material, and an elastic material.

18. A method of cushioning an orthodontic headgear strap, comprising:
feeding the orthodontic headgear strap through a longitudinal opening into a cavity in a headgear slip;
feeding a first and a second attachment through a first and a second opening in the headgear slip; and
positioning the orthodontic headgear strap flat inside of the headgear slip.

19. The method of cushioning an orthodontic headgear strap of claim 18, further comprising:
feeding the orthodontic headgear strap into an inner pocket; and
feeding the first and second attachment through a third and fourth opening located in the inner pocket and then through the first and second opening in the headgear slip.

20. The method of cushioning an orthodontic headgear strap of claim 19, further comprising placing a cushion into the pocket, wherein the cushion is positioned between the orthodontic headgear strap and an orthodontic headgear wearer.
